(19) United States
(12) Patent Application Publication
(10) Pub. No.: US 2011/0289289 A1
(43) Pub. Date: Nov. 24, 2011

(54) BACKUP AND RESTORE OF ITEMS USING BOUNDED CHECKPOINT AND LOG BUFFERS IN MEMORY

(75) Inventors: Yan Leshinsky, Kirkland, WA (US); Murali Brahmadesam, Woodinville, WA (US)

(73) Assignee: MICROSOFT CORPORATION, Redmond, WA (US)

(21) Appl. No.: 12/783,574

(22) Filed: May 20, 2010

(51) Int. Cl. G06F 12/16

(52) U.S. Cl. 711/162; 711/E12.103

(57) ABSTRACT

Architecture that is an efficient checkpoint process that performs backup and restore of checkpoint data items using bounded checkpoint buffers and log buffers in memory. Checkpoint processing can be performed using sequential inputs/outputs to a non-volatile storage medium (e.g., hard disk) on which the checkpoint files are persisted. Checkpoint processing is performed is in response to memory parameters that indicate the number or size of log entries accumulating in-memory relative to a memory threshold. In other words, given a bounded memory (e.g., cache), the rate of change of the log entries in the bounded memory triggers checkpoint processing.

### BACKGROUND

Many systems rely on checkpoints and logs for disaster recovery situations. Existing approaches for creating checkpoints include keeping as much of the checkpoint as possible in memory, applying the changes to checkpoint in memory and writing the changes to log files, and periodically flushing the checkpoint to disk and truncating the log files. Existing approaches for restoring items from a checkpoint include reading the entire log file and applying all the changes to the checkpoint.

However, there are issues in the above approach. While the logs are typically written and read in sequential manner, the checkpoint cannot be truly read and flushed in sequential manner. This is because the appropriate section of the checkpoint that would be affected by a log entry may not be in sequential order. Additionally, extra IOs (inputs/outputs) are required for persisting the log files, and the memory requirements can be large.

The above approach may be suited for highly resilient and generic applications such as databases where the substantial amount of checkpoint can be in memory to satisfy future operations; however, the approach is not suitable for applications that have requirements where the size of the checkpoint in memory should be bounded, checkpointing and restoration should involve efficient sequential IO only, and there is relaxed resiliency such that some loss of changes may be acceptable.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is an efficient checkpoint process that performs backup and restore of checkpoint data items using bounded checkpoint buffers and log buffers in memory. Checkpoint processing can be performed using sequential inputs/outputs to a non-volatile storage medium (e.g., hard disk) on which the checkpoint files are persisted. Checkpoint processing is performed is in response to memory parameters that indicate the number or size of log entries accumulating in-memory relative to a memory threshold. In other words, given a bounded memory (e.g., cache), the rate of change of the log entries in the bounded memory triggers checkpoint processing.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a data management system in accordance with the disclosed architecture.

FIG. 2 illustrates a more detailed embodiment of a data management system.

FIG. 3 illustrates a data management method in accordance with the disclosed architecture.

FIG. 4 illustrates further aspects of the method of FIG. 3.

FIG. 5 illustrates an alternative data management method.

FIG. 6 illustrates further aspects of the method of FIG. 5.

FIG. 7 illustrates a data management restore method.

FIG. 8 illustrates a block diagram of a computing system that executes backup and restore of data using bounded in-memory checkpoint buffers and log buffers in accordance with the disclosed architecture.

### DETAILED DESCRIPTION

The disclosed architecture performs checkpoint processing of persisted checkpoints through log entry updates stored in a bounded memory. Checkpoint blocks are sequentially read and updated by the log entries on a per-item basis, where some block data items may have updates to be applied and other data items do not have updates. When a checkpoint block has been fully processed, the completed block is sequentially written to a new persisted checkpoint. A restore operation can be performed in a similar fashion.

The following entity definitions are utilized herein. A source checkpoint is a checkpoint that is persisted as a file on a non-volatile storage media (e.g., a magnetic disk, optical disk, solid state disk, etc.). The source checkpoint file is used to create a new (target) checkpoint after applying log entries to it. A target checkpoint is a new checkpoint file that is created on the non-volatile storage media, from the source checkpoint, after log entries have been applied to the source checkpoint data blocks. Log entries are the changes (updates) that are to be applied to a checkpoint data item. Entries are maintained in memory in a data structure for efficient lookup (e.g., hash table).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

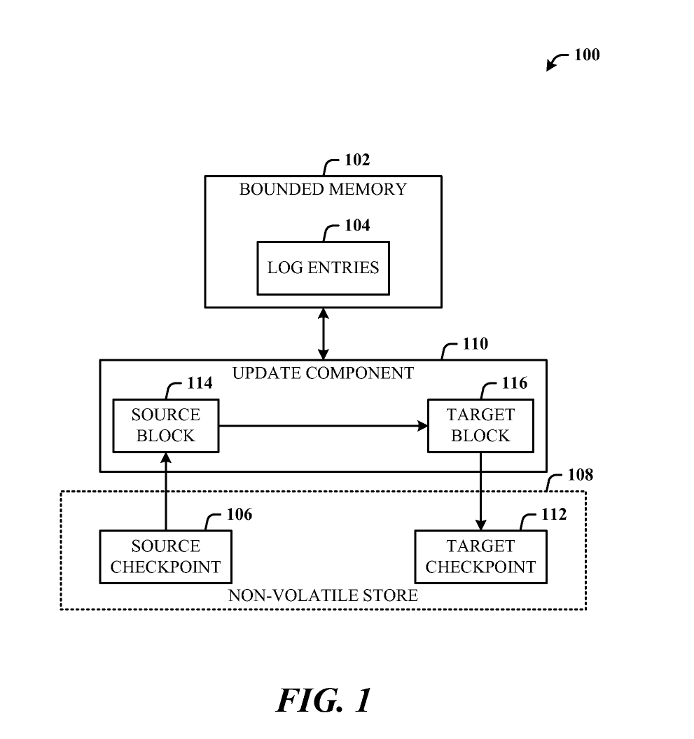

FIG. 1 illustrates a data management system 100 in accordance with the disclosed architecture. The system 100 includes a bounded memory 102 (volatile or non-volatile) that stores log entries 104 associated with updates to data of a source checkpoint 106 of a non-volatile store 108, and an update component 110 that processes updates to data of the source checkpoint 106 as the log entries 104 of the bounded memory 102 to create a target checkpoint 112.

The update component 110 initiates data processing of a checkpoint in response to a log entry parameter relative to a memory threshold. In other words, the rate of change of the entries 104 (e.g., size, number, etc.) in the memory 102 triggers checkpoint processing. The processing will then continue until the log entry parameter(s) indicate that processing is no longer needed as indicated (e.g., relative to the threshold). The update component 110 reads a portion of the data (e.g., a source block 114) from the source checkpoint 106 and updates items of the source block 114. The update component 110 serializes an updated item of the source block 114 to a target block 116 and removes a log entry (of the entries 104) associated with the update.

The update component 110 copies a non-updated item of the source block 114 to the target block 116. The update component 110 removes a log entry (of the entries 104) for an item from the memory 102 based on an update that indicates deletion of the item. The update component 110 sequentially reads data of the source checkpoint 106 for updates until the target block 116 is full and then sequentially writes the full target block 116 to the target checkpoint 112. The update component 110 enumerates log entries of updated items of the source checkpoint 106, to the target checkpoint 112.

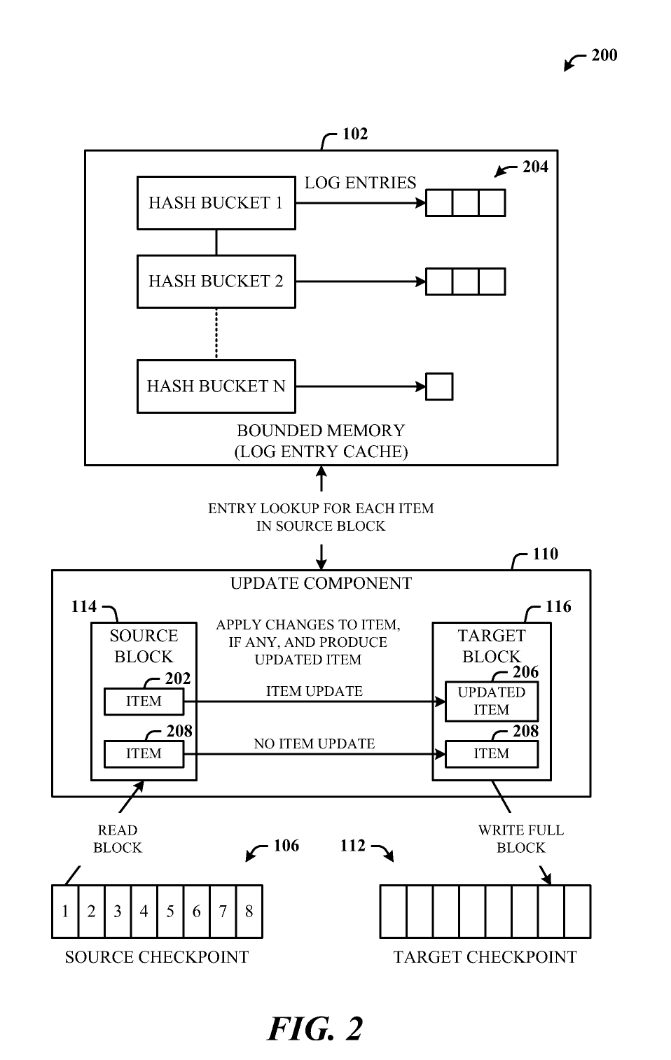

FIG. 2 illustrates a more detailed embodiment of a data management system 200. The system 200 includes the source checkpoint 106 shown as comprising blocks of data (e.g., eight), where a first block (the source block 114) is sequentially read from the source checkpoint 106 by the update component 110. The source block 114 includes one or more data items that are processed against the bounded memory 102 for log entry updates. A first data item 202 is processed against a hash data structure 204 of the memory 102 and updated to create an updated item 206 in the target block 116. Similarly, a second data item 208 is processed against the hash data structure 204 and found to not have an update. Thus, the non-updated second data item 208 is copied to the target block 116 as not being updated.

This process continues for each data item of the source block 114 until all source block items have been processed against the hash data structure 204 and the target block 116 is full. Once full, the target block is sequentially written to the target checkpoint 112. The process further continues by reading and processing all source blocks against the entries of the memory 102 to the target checkpoint 112. Thereafter, another source checkpoint is selectively processed.

Each log entry is assigned a generation number, and only entries with generation number less than N will be applied while creating a checkpoint N. Following is an algorithm that creates a generation N checkpoint from a generation N−1 checkpoint and generation N log. Initially, a log generation number is set to N+1. A block of data is then sequentially from the source checkpoint (of generation N−1). For each item in the source block, a check is made if a change has to be applied from the generation N log entries. If so, that entry is removed from the log entries, the change is applied to the item, and the changed item serialized to the target block.

If no change is available, the item is simply copied to the target block. If the change indicates that the associated data item is tagged for deletion, the log entry is removed from the log entry buffer, and the data item is skipped from being serialized to target block.

If the target block is full, the full target block is sequentially written it to the non-volatile store. Then, the next source block is read from the source checkpoint, and the process repeated until all source blocks of the source checkpoint have been processed. For all new inserts (entries applied to data items) in the target checkpoint, the generation N log entries are enumerated and the enumeration added to target checkpoint.

Following is an example restore algorithm. Assume that restore starts in the middle of the creation of a generation N checkpoint. Further assume that more than one restore enumeration can happen at the same time. Each enumeration is assigned enumeration number M. At this time, checkpoint creation has not been paused by an outgoing enumeration.

Next, checkpoint creation is paused and the pause point position in the source checkpoint at which the pause was initiated is remembered (stored). The step to remember the pause point is performed to avoid extra IO operations during restore. The enumeration number is then increased (e.g., M−1 is incremented to become M).

All the blocks are then sequentially read from the target checkpoint. For each item in the target block, a check is performed to determine if a change has to be applied from the generation N+1 log entries. If so, the data item is marked as enumerated by M, the change is then made to the item, and return is to the restore caller. If no change has occurred, the process returns to restore caller. If the change indicates that the data item has to be deleted, the item is marked as enumerated by M. The process then continues.

After all the blocks in the target checkpoint are exhausted (have been processed), flow is back to the source checkpoint to start reading in data beginning from the pause point position previously stored. All the remaining source blocks are then sequentially read from the source checkpoint. For each item in the source blocks, updates are applied using the generation N and N+1 log entries. For all new inserts, all log entries are enumerated with an enumeration number less than M and the enumerated log entries are returned to the restore caller. If this is the last enumeration in progress, the checkpoint generation is resumed.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

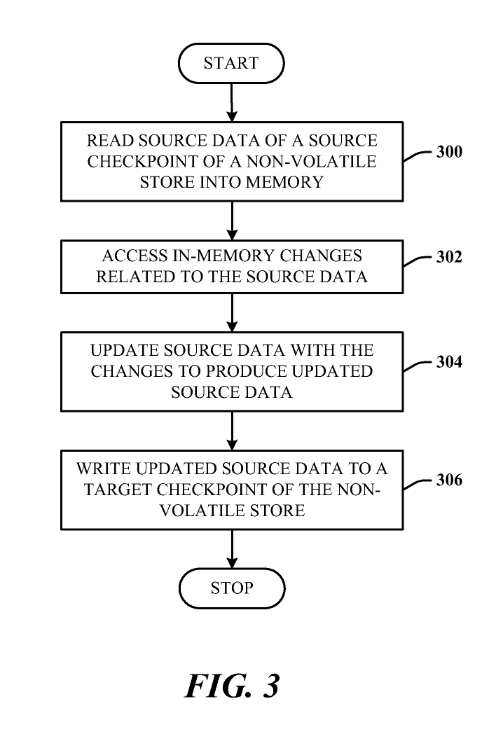

FIG. 3 illustrates a data management method in accordance with the disclosed architecture. At 300, source data of a source checkpoint of a non-volatile store is read into memory. At 302, in-memory changes related to the source data are accessed. At 304, the source data is updated with the changes to produce updated source data. At 306, the updated source data is written to a target checkpoint of the non-volatile store.

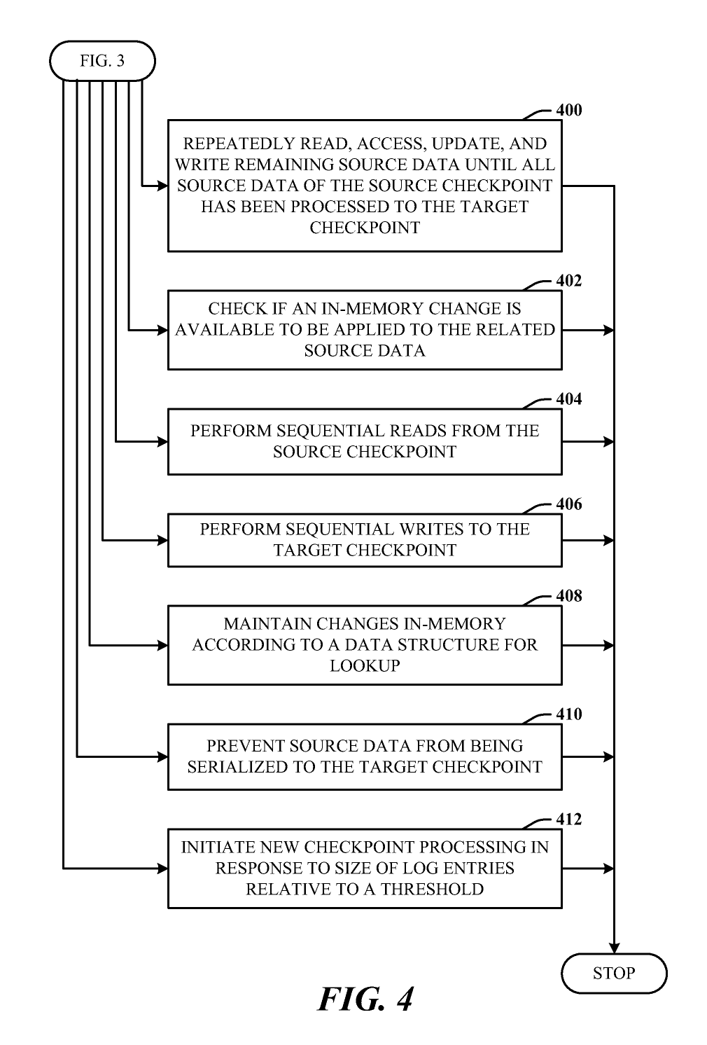

FIG. 4 illustrates further aspects of the method of FIG. 3. At 400, remaining source data is repeatedly read, accessed, updated, and written until all source data of the source checkpoint has been processed to the target checkpoint. At 402, as check is made if an in-memory change is available to be applied to the related source data. At 404, sequential reads from the source checkpoint are performed. At 406, sequential writes to the target checkpoint are performed. At 408, the changes are maintained in-memory according to a data structure for lookup. At 410, the source data is prevented from being serialized to the target checkpoint. At 412, new checkpoint processing is initiated in response to size of log entries relative to a threshold.

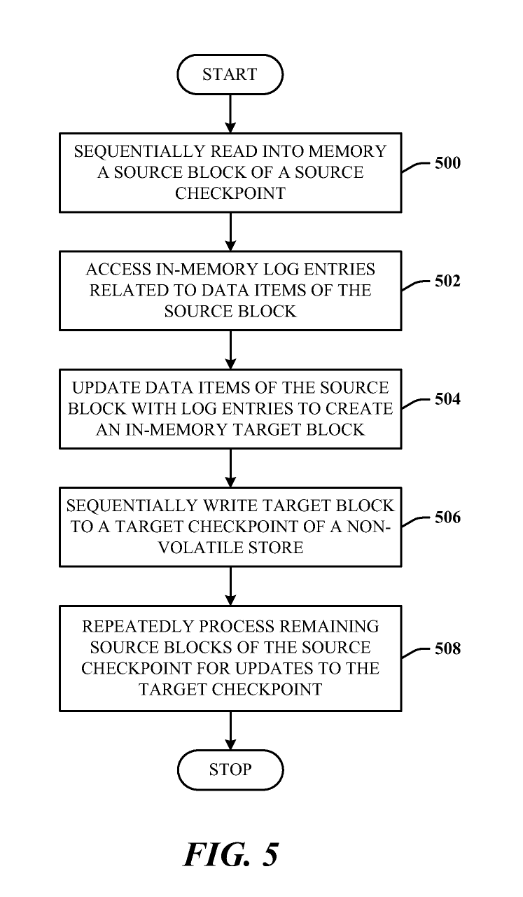

FIG. 5 illustrates an alternative data management method. At 500, a source block of a source checkpoint is sequentially read into memory. At 502, in-memory log entries related to data items of the source block are accessed. At 504, data items of the source block are updated with log entries to create an in-memory target block. At 506, the target block is sequentially written to a target checkpoint of a non-volatile store. At 508, remaining source blocks of the source checkpoint are repeatedly processed for updates to the target checkpoint.

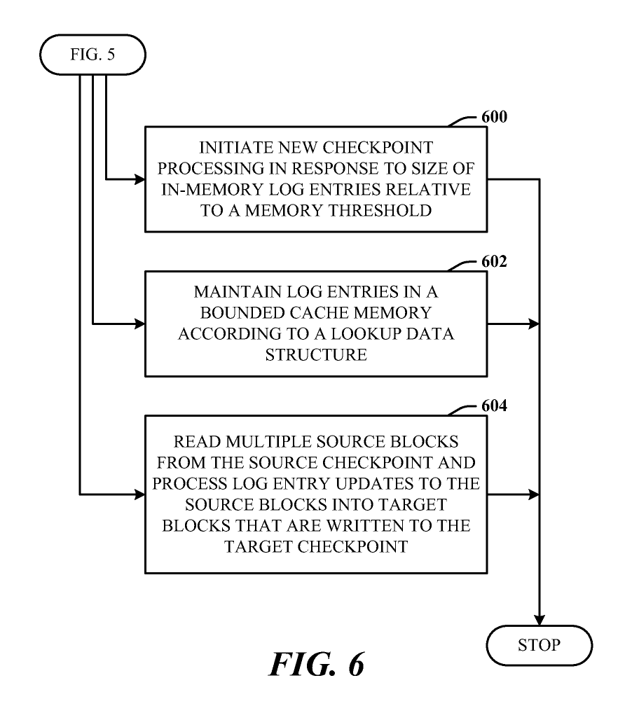

FIG. 6 illustrates further aspects of the method of FIG. 5. At 600, new checkpoint processing is initiated in response to size of in-memory log entries relative to a memory threshold. At 602, the log entries are maintained in a bounded cache memory according to a lookup data structure. At 604, multiple source blocks are read from the source checkpoint and log entry updates to the source blocks are processed into target blocks that are written to the target checkpoint.

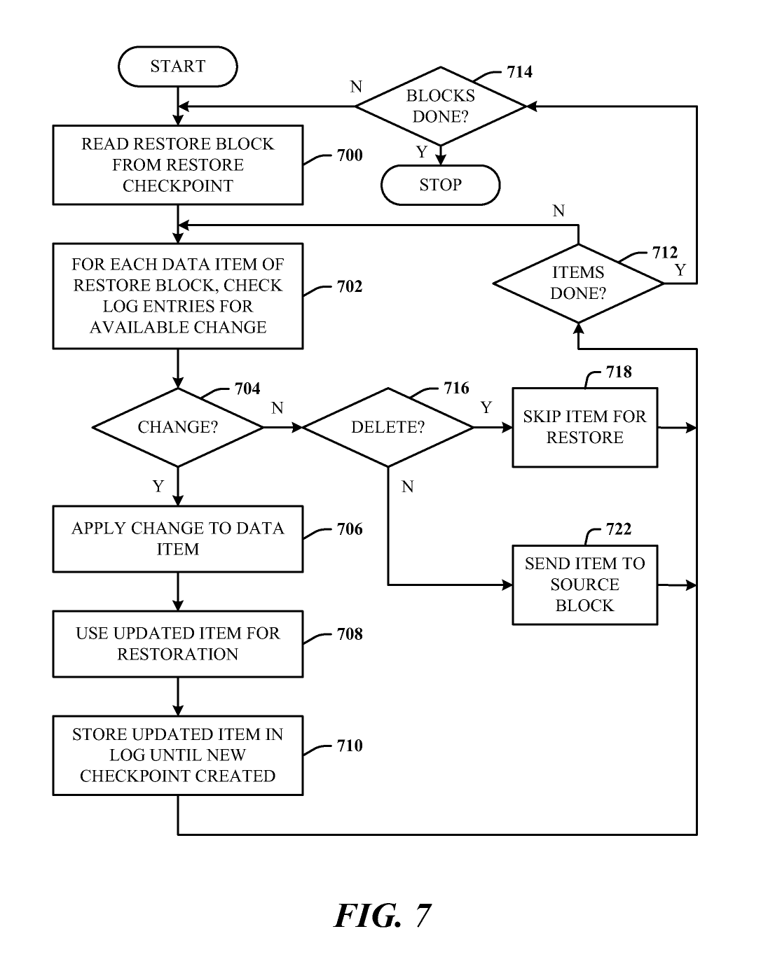

FIG. 7 illustrates a data management restore method. An algorithm for restoring a source checkpoint from a restore checkpoint can be the following. At 700, a restore block is read from a restore checkpoint from which restoration is to occur. At 702, for each data item in the restore block, a check is made at 704 to determine if a change is to be applied from the log entries. If so, flow is from 704 to 706 where the change is made to the data item. At 708, the updated item is used for restoration. At 710, the updated entry is stored in the log until a new checkpoint is created. Flow is then to 712 to determine if item processing is done. If not, item processing continues at 702; however, if so, processing moves to 714 to determine if block processing is done. If so, the restore process stops (or moves to standard checkpoint processing or another restore operation). If not, flow is to 700 to read another restore block and continue processing as described herein with the restore algorithm.

At 704, if no change is to be applied, flow is to 716 to determine if the data item is to be deleted. The log entry indicates if the item is to be deleted. If so, flow is to 718 to skip the item for restoration. Flow is then to 712 to check for finished item processing. If, at 716, the item is not to be deleted, flow is to 722 to send the item to the source block. Flow is then to 712 to check for item processing completion. If not, flow is to 702 to continue. However, if item processing for this block is done, flow is from 712 to 714 to check is block processing is done. If not, flow is to 700 where the next block is read from the restore checkpoint, and processing continues until all blocks have been processed and the restore checkpoint is exhausted.

Note that only two checkpoint blocks are processed in memory at any given time. Moreover, new checkpoint creation is triggered when the size of the log entries reached a threshold. Thus, the memory consumption of the log entries is also bounded. As previously indicated the IOs to both source and target checkpoint files are sequential. Additionally, if restoration performance needs to be increased, more restore blocks can be read at any given time. That is, when the restore operation begins, a single restore block is processed, but as restore proceeds, multiple restore blocks can be read for processing. Note that even in this case, the memory limitations can be maintained as bounded.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

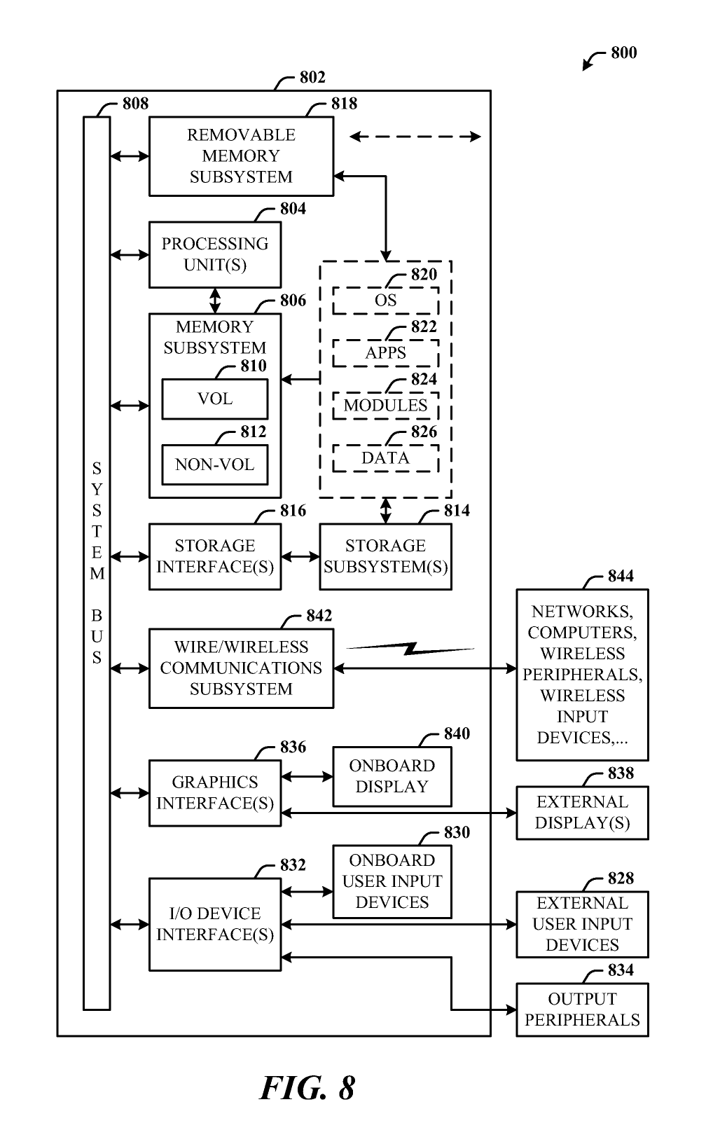

Referring now to FIG. 8, there is illustrated a block diagram of a computing system 800 that executes backup and restore of data using bounded in-memory checkpoint buffers and log buffers in accordance with the disclosed architecture. In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a computer-readable storage such as a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include computer-readable storage (physical storage media) such as a volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The one or more application programs 822, other program modules 824, and program data 826 can include the update component 110 and associated functionality and, backup and restore algorithms as described herein, and the methods represented by the flowcharts of FIGS. 3-7, for example. Moreover, the memory subsystems (808, 818) and storage subsystem 814, for example, can employ the bounded memory backup and restore components described herein.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 802 and includes volatile and non-volatile internal and/or external media that is removable or non-removable. For the computer 802, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wireles sly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented data management system having computer readable media that store executable instructions executed by a processor, comprising:
a bounded memory that stores log entries associated with updates to data of a source checkpoint of a non-volatile store; and
an update component that processes updates to data of the source checkpoint to create a target checkpoint.

2. The system of claim 1, wherein the update component initiates data processing of a checkpoint in response to a log entry parameter relative to a memory threshold.

3. The system of claim 1, wherein the update component reads a source block from the source checkpoint and updates items of the source block.

4. The system of claim 3, wherein the update component serializes an updated item of the source block to a target block and removes a log entry associated with the update.

5. The system of claim 3, wherein the update component copies a non-updated item of the source block to a target block.

6. The system of claim 3, wherein the update component removes a log entry for an item from the memory based on an update that indicates deletion of the item.

7. The system of claim 1, wherein the update component sequentially reads data of the source checkpoint for updates until a target block is full and then sequentially writes the full target block to the target checkpoint.

8. The system of claim 1, wherein the update component enumerates log entries of updated items of the source checkpoint, to the target checkpoint.

9. A computer-implemented data management method executed via a processor, comprising:
reading source data of a source checkpoint of a non-volatile store into memory;
accessing in-memory changes related to the source data;
updating the source data with the changes to produce updated source data; and
writing the updated source data to a target checkpoint of the non-volatile store.

10. The method of claim 9, further comprising repeatedly reading, accessing, updating, and writing remaining source data until all source data of the source checkpoint has been processed to the target checkpoint.

11. The method of claim 9, further comprising checking if an in-memory change is available to be applied to the related source data.

12. The method of claim 9, further comprising performing sequential reads from the source checkpoint.

13. The method of claim 9, further comprising performing sequential writes to the target checkpoint.

14. The method of claim 9, further comprising maintaining the changes in-memory according to a data structure for lookup.

15. The method of claim 9, further comprising preventing the source data from being serialized to the target checkpoint.

16. The method of claim 9, further comprising initiating new checkpoint processing in response to size of log entries relative to a threshold.

17. A computer-implemented data management method executed via a processor, comprising:
sequentially reading into memory a source block of a source checkpoint;
accessing in-memory log entries related to data items of the source block;
updating data items of the source block with log entries to create an in-memory target block;
sequentially writing the target block to a target checkpoint of a non-volatile store; and
repeatedly processing remaining source blocks of the source checkpoint for updates to the target checkpoint.

18. The method of claim 17, further comprising initiating new checkpoint processing in response to size of in-memory log entries relative to a memory threshold.

19. The method of claim 17, further comprising maintaining the log entries in a bounded cache memory according to a lookup data structure.

20. The method of claim 17, further comprising reading multiple source blocks from the source checkpoint and processing log entry updates to the source blocks into target blocks that are written to the target checkpoint.
